(19) United States
(12) Patent Application Publication
(10) Pub. No.: US 2013/0168936 A1
(43) Pub. Date: Jul. 4, 2013

(54) SKATEBOARD

(71) Applicant: Shuei Morita, Shiga (JP)

(72) Inventor: Shuei Morita, Shiga (JP)

(21) Appl. No.: 13/635,917

(22) PCT Filed: Mar. 22, 2011
(86) PCT No.: PCT/JP2011/056859

§ 371 Date: Nov. 1, 2012

(30) Foreign Application Priority Data
Mar. 20, 2010 (JP) 2010-065320

(51) Int. Cl. B62M 1/00

(52) U.S. Cl. CPC B62M 1/00
USPC 280/87.042

(57) ABSTRACT

Provided is a skateboard that enables propulsion to be gained efficiently by a user in a riding state without having to kick the ground with one foot and that also has excellent stability. In a skateboard 1 in which a front board 2 and a rear board 3 attached with casters 6 and 7 respectively at the bottom surface thereof are connected by a connecting member 4, the connecting member 4 includes, at least in a middle portion in the front-rear direction, a plate-shaped spring section 41 elastically deformed upon application of a force orthogonal to a broad side 41a, and is connected to the front board 2 and the rear board 3 such that the broad side 41a is in a vertical direction.

### TECHNICAL FIELD

The present invention relates to a skateboard provided with separate front and rear boards and a connecting member that connects these boards.

### BACKGROUND ART

Currently, skateboards have become widespread as playground equipment, sports equipment, or balance training equipment. A general skateboard has a board and casters provided at the front and rear on the bottom surface thereof, as its basic components. A user gets on the board and kicks the ground with one foot to gain propulsion, and the user can make a turn by tilting the board to the left and right.

Conventionally, various improvements have been made in skateboards, and the one in which a front board and a rear board are separated from each other and these front board and rear board are connected by a connecting member has been proposed or developed. For example, Patent Document 1 describes a skateboard in which a front board and a rear board are connected with a spring. In this skateboard, the flexibility and elastic force of the spring is considered to increase the motion capability of the skateboard. Patent Document 2 describes a skateboard in which a front board and a rear board are connected with a twist pipe and elastic rubber arranged on both sides thereof and parallel thereto. In this skateboard, it is considered that the elastic restoring force of the twist pipe and the elastic rubber enables rotation at a small radius, and that, while a user is riding the skateboard, propulsion can be gained merely through a twisting motion of the body of the user in a riding state without having to kick the ground with one foot. With two front and rear boards that are separated from each other, and the front board and the rear board being connected by a connecting member in this manner, propulsion can be gained by the elastic force of the connecting member. Therefore, regardless of whether the user is inexperienced or skilled, riding time can be increased, and one can enjoy the process of learning the techniques of gaining propulsion.
Patent Document 1: Japanese Utility Model Application Laid-open No. H1-117385
Patent Document 2: Japanese Translation of PCT Application No. 2005-537820

However, with the skateboard described in Patent Document 1, a vertical bend in the connecting member and an effect of reaction caused thereby may render a stable ride difficult, when the center of gravity of the foot of the user is displaced from a position right above a caster. With the skateboard described in Patent Document 2, the twist pipe of the connecting member is a rigid body and therefore does not bend vertically, but there is room for improvement in terms of propulsion.

### DISCLOSURE OF THE INVENTION

The present invention has been made in view of the matters described above, and an object thereof is to provide a skateboard that enables propulsion to be gained efficiently by a user in a riding state without having to kick the ground with one foot and that also has excellent stability.

In order to achieve the object described above, a skateboard according to a preferred embodiment of the present invention is a skateboard in which a front board and a rear board each attached with a caster at a bottom surface thereof are connected by a connecting member, wherein the connecting member includes, at least in a middle portion in a front-rear direction, a plate-shaped spring section elastically deformed upon application of a force orthogonal to a broad side, and is connected to the front board and the rear board such that the broad side is in a vertical direction.

Preferably, the connecting member is closely in contact with and encompassed by a protecting member having elasticity.

Preferably, each of the casters is formed to have: a first attachment member attached to the bottom surface of the front board or the rear board in a rotatable state; a second attachment member attached to the first attachment member in a rotatable state with an axial direction being an orthogonal direction with respect to an axis of rotation of the first attachment member; a roller attached to the second attachment member and having a rolling section that is rotatable with an axial direction being a parallel direction to an axis of rotation of the second attachment member; and a spring member attached between the first attachment member and the second attachment member.

With the skateboard of the present invention, propulsion can be gained efficiently by a user in a riding state without having to kick the ground with one foot since the plate-shaped spring section curves with an elastic restoring force in the horizontal direction, and a vertical bend of the connecting member or instability due to an effect of reaction caused thereby can be prevented for excellent stability even if the center of gravity of a foot of the user is displaced from a position right above the caster since the plate-shaped spring section hardly curves in the vertical direction.

### BRIEF DESCRIPTION OF THE DRAWINGS

FIG. 1A is a side view of a skateboard 1 according to an embodiment of the present invention;

FIG. 1B is a bottom view of the skateboard 1 according to the embodiment of the present invention;

FIG. 2A is a side view showing an enlargement of a connecting member 4 and a protecting member 5 of the skateboard 1 according to the embodiment of the present invention;

FIG. 2B is a bottom view showing an enlargement of the connecting member 4 and the protecting member 5 of the skateboard 1 according to the embodiment of the present invention;

FIG. 3A is a sectional view showing an enlargement of a sectional surface along line A-A or line A′-A′ in FIG. 1 of the skateboard 1 according to the embodiment of the present invention;

FIG. 3B is a sectional view showing an enlargement of a sectional surface along line B-B or line B′-B′ in FIG. 1 of the skateboard 1 according to the embodiment of the present invention;

FIG. 4A is a bottom view showing an enlargement of a modification example 4′ of the connecting member 4 of the skateboard 1 according to the embodiment of the present invention;

FIG. 4B is a bottom view showing an enlargement of a modification example 4″ of the connecting member 4 of the skateboard 1 according to the embodiment of the present invention;

FIG. 5A is a side view showing an enlargement of a caster 6 of the skateboard 1 according to the embodiment of the present invention;

FIG. 5B is a bottom view showing an enlargement of the caster 6 of the skateboard 1 according to the embodiment of the present invention; and

FIG. 5C is a bottom view showing an enlargement of the caster 6 of the skateboard 1 in a state where a roller 63 is removed according to the embodiment of the present invention.

### BEST MODE FOR CARRYING OUT THE INVENTION

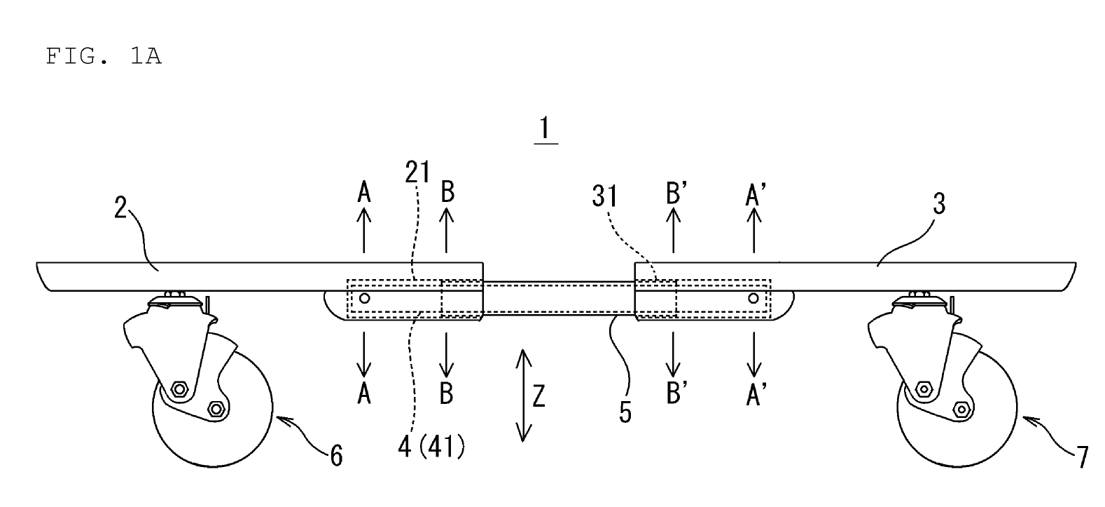

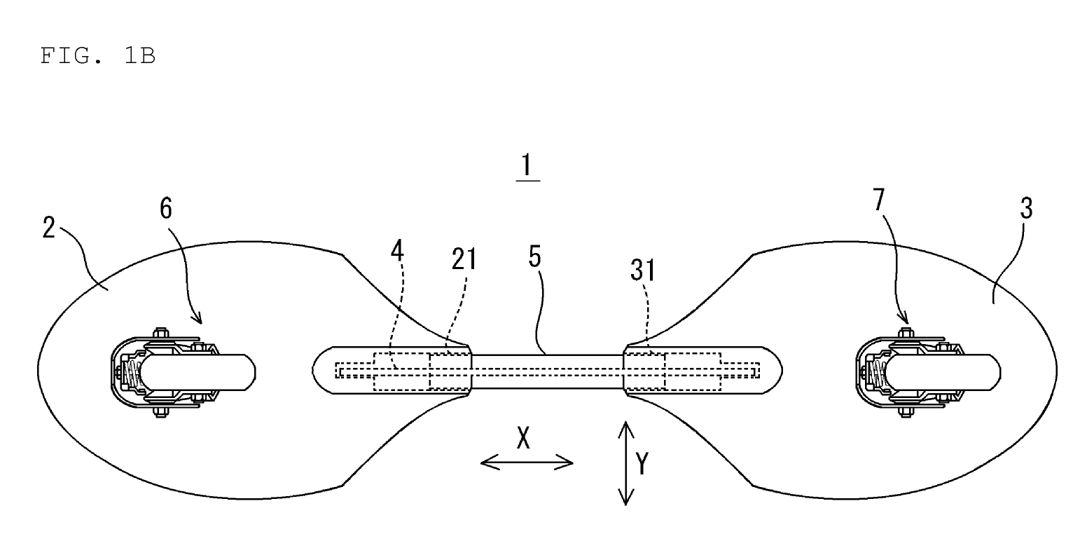

A preferred embodiment for carrying out the present invention will be described below with reference to the drawings. As shown in FIG. 1, a skateboard 1 according to an embodiment of the present invention is configured to have a front board 2, a rear board 3, a connecting member 4 for connection thereof, a protecting member 5 that encompasses the connecting member 4, and casters (a front caster 6 and a rear caster 7) attached respectively to bottom surfaces of the front board 2 and the rear board 3. The front board 2 and the rear board 3 have a predetermined thickness and have a width and length sufficiently greater than the thickness. The size and material therefor are not particularly limited, and it suffices to use those that are common. Hereinafter, the thickness direction (Z-direction shown in FIG. 1A) is referred to as a vertical direction, the width direction (Y-direction shown in FIG. 1B) as a horizontal direction, and the length direction (X-direction shown in FIG. 1B) as a front-rear direction.

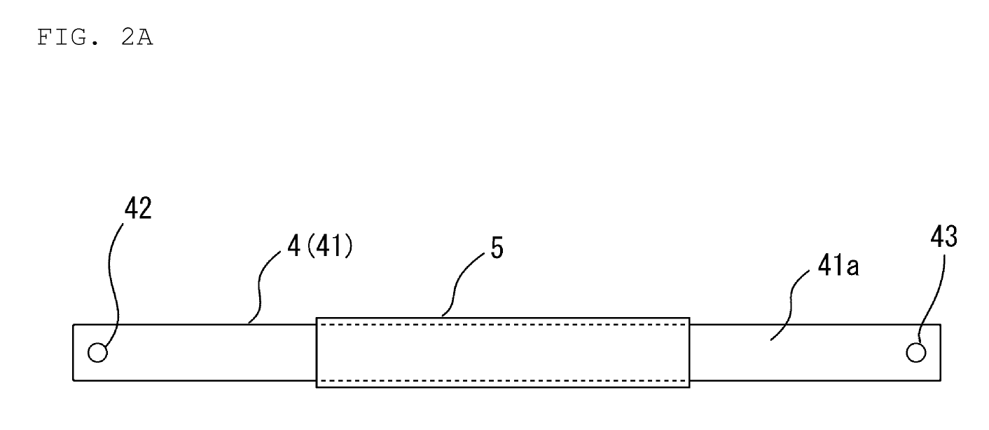

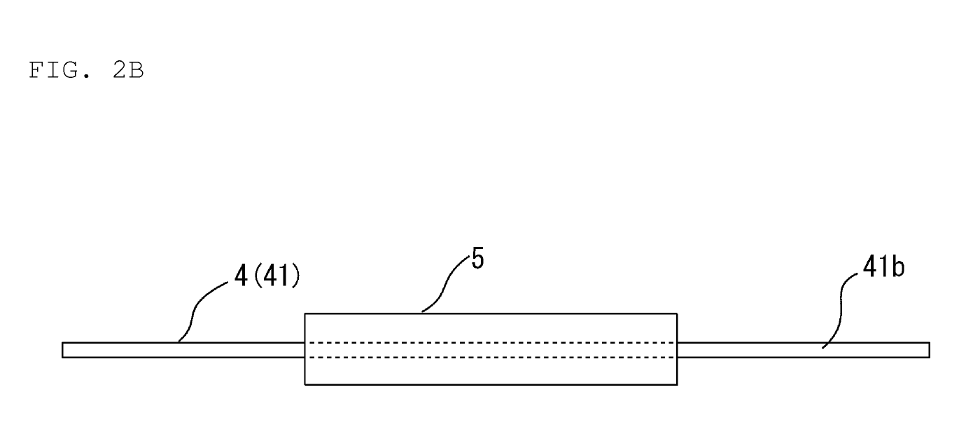

As shown in FIG. 2, the connecting member 4 is formed of a plate-shaped spring section 41 that has a predetermined thickness (plate thickness) and stretches with a width (plate width) sufficiently greater than the thickness. The plate-shaped spring section 41 is elastically deformed, i.e., curved with elastic restoring force, when applied with a force orthogonal to a broad side (surface showing the plate width) 41a, but is hardly elastically deformed even if applied with a force orthogonal to a narrow side (surface showing the plate thickness) 41b. The plate-shaped spring section 41 is commonly formed of metal (for example, stainless steel).

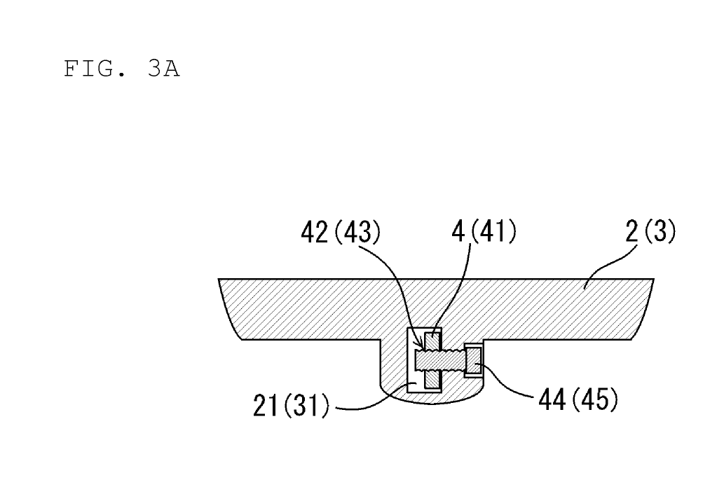

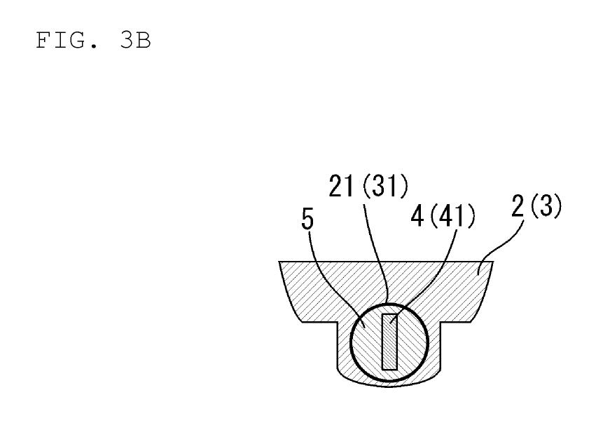

The plate-shaped spring section 41 in a state where the front and rear boards 2 and 3 are connected is stretched in the front-rear direction, such that the broad side 41a is in the vertical direction and the narrow side 41b is in the horizontal direction. Thus, the plate-shaped spring section 41 can be elastically deformed in the horizontal direction. The plate-shaped spring section 41 specifically is provided, in the vicinity of both ends thereof, with penetration holes 42 and 43 formed with a thread, and bolts 44 and 45 are passed therethrough to tighten the front and rear boards 2 and 3, as shown in FIG. 3A.

With such a configuration, energy is stored by causing the front board 2 and the rear board 3 to be in a positional relationship where the plate-shaped spring section 41 is curved with an elastic restoring force in the horizontal direction and the stored energy is transformed into propulsion by the ensuing restoration of the plate-shaped spring section 41, when a user gets on and rides the skateboard 1 placed on the ground. On the other hand, the plate-shaped spring section 41 hardly curves in the vertical direction and does not bend. Accordingly, even if the center of gravity of a foot of the user is displaced from a position right above the front caster 6 or the rear caster 7, a vertical bend of the connecting member 4 or instability due to an effect of reaction caused thereby can be prevented to enable a stable ride. Note that when the front board 2 and the rear board 3 are relatively inclined, propulsion is gained by the plate-shaped spring section 41 being curved and twisted in the horizontal direction with an elastic restoring force, and a bend hardly occurs in the vertical direction. In this manner, the plate-shaped spring section 41 enables the skateboard 1 to gain propulsion efficiently by a user in a riding state without having to kick the ground with one foot, and moreover to have excellent stability.

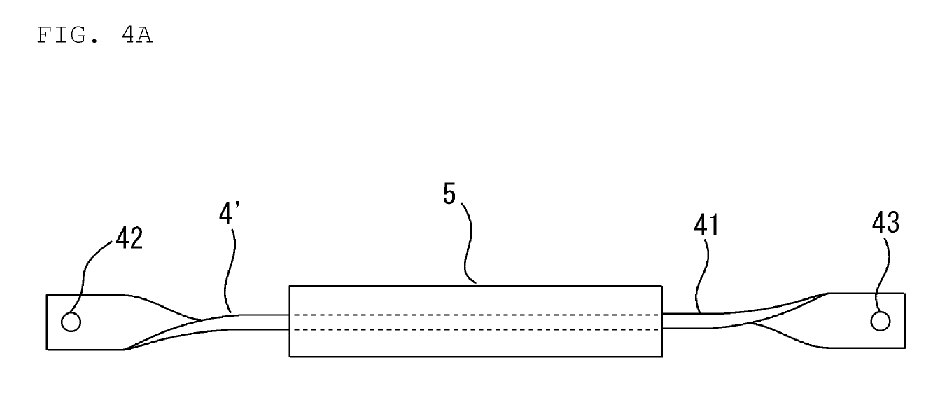

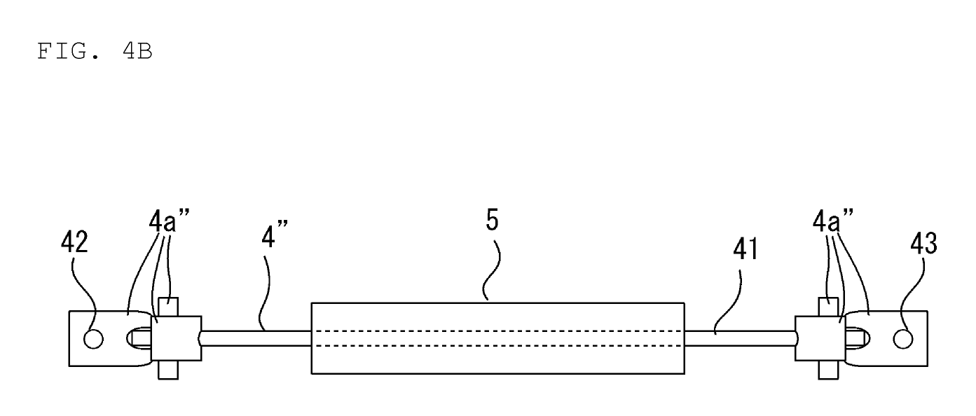

Although an example in which the connecting member 4 is formed only of the plate-shaped spring section 41 has been described, it suffices that the plate-shaped spring section 41 be provided at least in a middle portion in the front-rear direction (stretch direction), and the embodiment may be modified in various ways. For example, in connecting members 4′ and 4″ shown in FIGS. 4A and 4B, the plate-shaped spring section 41 is formed in the middle portion, including a center point, in the front-rear direction. In the connecting member 4′, there is a twist of 90 degrees near and on the center side of the penetration holes 42 and 43 as shown in FIG. 4A. In the connecting member 4″, additional members 4a″ provided with the penetration holes 42 and 43 in the vertical direction are adhered integrally to the plate-shaped spring section 41 as shown in FIG. 4B. In the connecting members 4′ and 4″, tightening members (not shown) pass through the penetration holes 42 and 43 in the vertical direction for tightening. Note that, in terms of simplicity in manufacturing steps and mechanical strength, the connecting member 4 described above is superior to the connecting members 4′ and 4″.

The protecting member 5 protects the connecting member 4 so that the connecting member 4 does not receive damage upon impact with an object or the like, and preferably has elasticity (for example, is formed of urethane rubber or formed of silicon rubber) to make a close contact with and encompass the middle portion of the connecting member 4. Accordingly, the protecting member 5 acts as a resistance against the elastic deformation of the connecting member 4. Therefore, by adjusting the elasticity of the protecting member 5, the degree of curve in the connecting member 4 can be made to adapt to the skill level of the user. Further preferably, as shown in FIG. 1, it may be such that recess sections 21 and 31 into which the connecting member 4 and the protecting member 5 are fitted are formed on the bottom surface side of the front board 2 and the rear board 3, and the protecting member 5 is inserted to contact the recess sections 21 and 31 so that the connecting member 4 is connected to the front and rear boards 2 and 3. In this case, the protecting member 5 has a cylindrical shape, the sectional surface of the recess sections 21 and 31 in the vicinity of an entrance at which the protecting member 5 is inserted has, as shown in FIG. 3B, a circular shape, and the sectional surface at a deep section where only the connecting member 4 is inserted has, as shown in FIG. 3A, a rectangular shape. Accordingly, when the connecting member 4 is curved, local force applied to the penetration holes 42 and 43 of the connecting member 4 can be distributed due to an outside surface of the protecting member 5 being supported by an inner wall of the recess sections 21 and 31, thus enhancing the mechanical strength of the connecting member 4.

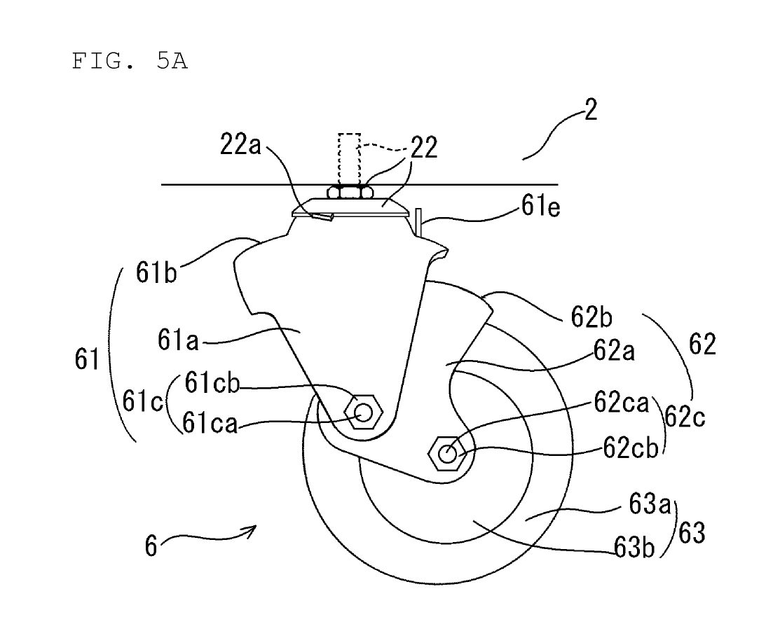

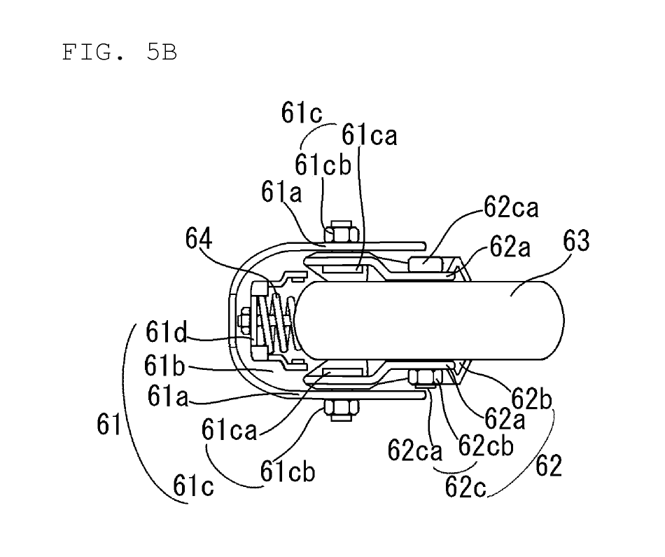

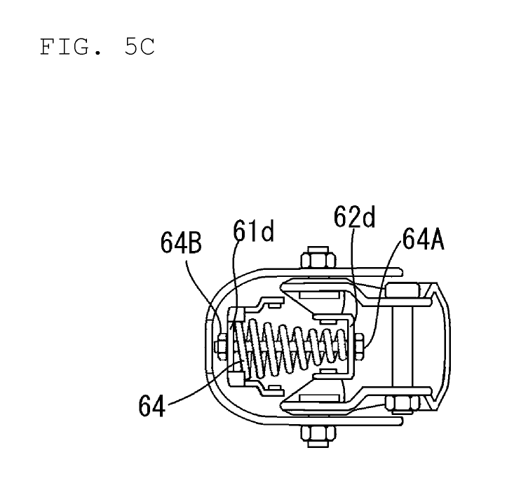

The front caster 6 and the rear caster 7 have similar structures, are attached to bottom surfaces of the front board 2 and the rear board 3 in a similar manner, and operate in a similar manner. The front caster 6 will be described below as a representative. As shown in FIG. 5, the front caster 6 is formed to have a first attachment member 61 attached to the bottom surface of the front board 2 in a rotatable state, a second attachment member 62 attached to the first attachment member 61 in a rotatable state with the axial direction being an orthogonal direction with respect to the axis of rotation of the first attachment member 61 (axis about which the first attachment member 61 rotates), a roller 63 attached to the second attachment member 62 and having a rolling section 63a that is rotatable with the axial direction being a parallel direction to the axis of rotation of the second attachment member 62 (axis about which the second attachment member 62 rotates), and a spring member 64 attached between the first attachment member 61 and the second attachment member 62. Note that FIG. 5C is a view in which the roller 63 is removed, for the sake of a better understanding.

More specifically, a shaft section 22 is provided to be upright at the bottom surface of the front board 2, and the first attachment member 61, i.e., the front caster 6 including the same, is attached to the shaft section 22 in a rotatable state. The upright direction of the shaft section 22 is the direction of the axis of rotation of the first attachment member 61. Note that in the periphery of the shaft section 22, a stopper 22a is provided to protrude in a direction orthogonal to the axial direction, such that, when the first attachment member 61 rotates more than a predetermined amount, contact with a bar body section 61e provided to the first attachment member 61 restricts the rotatable range of the first attachment member 61. By using an elastic material in consideration of the speed and stability of the skateboard 1, it is possible to cause the attachment member 61 to restore an original normal state upon rotation with respect to the shaft section 22 or to cause the shaft section 22 to be inclined with respect to the bottom surface of the front board 2.

The first attachment member 61 specifically is formed in an approximate U-shape with two opposing pieces 61a and a connecting piece 61b for connection thereof and is attached to the shaft section 22 at the connecting piece 61b. The first attachment member 61 has shaft sections 61c provided orthogonally to the respective two opposing pieces 61a. The shaft sections 61c are formed of a bolt 61ca formed with a thread in a portion to which a nut 61cb is to be screwed and the nut 61cb. Thus, the shaft sections 61c are arranged in an orthogonal direction with respect to the axis of rotation of the first attachment member 61. This becomes the axis of rotation of the second attachment member 62, which will be described next, and the second attachment member 62 is attached to be freely rotatable.

The second attachment member 62 specifically is formed in an approximate U-shape with two opposing pieces 62a and a connecting piece 62b for connection thereof such that the outer dimension of the two opposing pieces 62a is slightly smaller than the inner dimension of the two opposing pieces 61a of the first attachment member 61, and is attached in a rotatable state to the two shaft sections 61c of the first attachment member 61 at the two opposing pieces 62a. The second attachment member 62 has a shaft section 62c provided in a position slightly apart from the two shaft sections 61c of the first attachment member 61 to bridge the two opposing pieces 62a. Thus, the shaft section 62c is arranged in a parallel direction to the axis of rotation of the second attachment member 62. The shaft section 62c is formed of a bolt 62ca that bridges the two opposing pieces 62a and that is formed with a thread in a portion to which a nut 62cb is to be screwed and the nut 62cb.

The roller 63 specifically is formed of a roller shaft section 63b and the rolling section 63a that is freely rotatable in the periphery thereof. The roller shaft section 63b is attached to be fixed in the periphery of the bolt 62ca of the second attachment member 62.

The spring member 64 specifically is attached between a support section 61d provided inward as a part of the first attachment member 61 and a support section 62d provided inward as a part of the second attachment member 62. The spring member 64 is caused to elevate (approach the front board 2) by the roller 63 receiving pressure from the ground and is compressed when the second attachment member 62 rotates accordingly with respect to the first attachment member 61. Note that a bolt 64A is inserted, with a head section 64Aa thereof being on the outside of the support section 62d, into a center portion of the spring member 64 and is attached between the support section 62d and the support section 61d by a nut 64B on the outside of the support section 61d. The bolt 64A stabilizes the attachment position of the second attachment member 62 with respect to the first attachment member 61, and the head section departs from the support section 62d upon compression of the spring member 64 and becomes a stopper upon extension caused by a reaction.

With such a configuration, the rolling section 63a of the roller 63 rotates in accordance with the speed of the skateboard 1, when the user gets on and rides the skateboard 1 placed on the ground. In accordance with the state of the ground or the center of gravity of the user, the second attachment member 62 rotates with respect to the first attachment member 61 such that the spring member 64 is compressed. At this time, due to elastic deformation, the spring member 64 contracts while absorbing the force received from the ground via the roller 63 and tries to return to normal when the force weakens. As a result, impact due to a sudden change in the state of the ground or the center of gravity of the user is mitigated. In accordance with the state of the ground or the center of gravity of the user, the first attachment member 61 rotates with respect to the bottom surface of the front board 2.

In this manner, impact due to a sudden change in the state of the ground or the center of gravity of the user is mitigated by the front caster 6 (and the rear caster 7, although description has been omitted). On the other hand, the plate-shaped spring section 41 of the connecting member 4 is hardly elastically deformed in the vertical direction as described above and therefore hardly contributes to buffering in that direction. Therefore, buffering by the second attachment member 62, the spring member 64, and the first attachment member 61 is extremely effective. This buffering gives a feeling close to snowboarding or surfboarding and thus is also suitable for balance training therefor.

The skateboard as the embodiment of the present invention has been described above, but the present invention is not limited to the configuration described in the embodiment, and various modifications in design are possible without departing from the scope of claims. For example, the specific structures of the front caster 6 and the rear caster 7 may be modified appropriately. Although the advantage described above of mitigating the impact due to a sudden change in the state of the ground or the center of gravity of the user cannot be obtained, a common part without the spring member 64 may also be used depending on the situation instead of the front caster 6 and the rear caster 7.

### EXPLANATION OF REFERENCE NUMERALS

1 Skateboard
2 Front board
3 Rear board
4 Connecting member
41 Plate-shaped spring section
41a Broad side of plate-shaped spring section 41
5 Protecting member
6 Caster of front board 2
61 First attachment member of caster 6
62 Second attachment member of caster 6
63 Roller of caster 6
63a Rolling section of roller 63
64 Spring member of caster 6
7 Caster of rear board 3

1. A skateboard in which a front board and a rear board each attached with a caster at a bottom surface thereof are connected by a connecting member,
wherein the connecting member includes, at least in a middle portion in a front-rear direction, a plate-shaped spring section elastically deformed upon application of a force orthogonal to a broad side, and is connected to the front board and the rear board such that the broad side is in a vertical direction.

2. The skateboard according to claim 1, wherein the connecting member is closely in contact with and encompassed by a protecting member having elasticity.

3. The skateboard according to claim 1, wherein each of the casters is formed to have:
a first attachment member attached to the bottom surface of the front board or the rear board in a rotatable state;
a second attachment member attached to the first attachment member in a rotatable state with an axial direction being an orthogonal direction with respect to an axis of rotation of the first attachment member;
a roller attached to the second attachment member and having a rolling section that is rotatable with an axial direction being a parallel direction to an axis of rotation of the second attachment member; and
a spring member attached between the first attachment member and the second attachment member.

4. The skateboard according to claim 2, wherein each of the casters is formed to have:
a first attachment member attached to the bottom surface of the front board or the rear board in a rotatable state;
a second attachment member attached to the first attachment member in a rotatable state with an axial direction being an orthogonal direction with respect to an axis of rotation of the first attachment member;
a roller attached to the second attachment member and having a rolling section that is rotatable with an axial direction being a parallel direction to an axis of rotation of the second attachment member; and
a spring member attached between the first attachment member and the second attachment member.
